(19) United States
(12) Patent Application Publication
(10) Pub. No.: US 2026/0133033 A1
(43) Pub. Date: May 14, 2026

(54) LOOP PIGTAIL COMPENSATION METHOD FOR FIBER-OPTIC GYROSCOPE, AND FIBER LENGTH COMPENSATOR

(71) Applicant: China State Shipbuilding Corp No 707 Res Inst, Tianjin (CN)

(72) Inventors: Bohan LIU, Tianjin (CN); Wenlong ZUO, Tianjin (CN); Wei LUO, Tianjin (CN); Miao YAN, Tianjin (CN); Xiaole WU, Tianjin (CN)

(21) Appl. No.: 18/874,880

(22) PCT Filed: Dec. 29, 2022
(86) PCT No.: PCT/CN2022/143149

§ 371 Date: Oct. 27, 2025

(30) Foreign Application Priority Data
Aug. 1, 2022 (CN) 202210915632.5

(51) Int. Cl. G01C 19/72

(52) U.S. Cl. CPC G01C 19/722

(57) ABSTRACT

A loop pigtail compensation method for a fiber-optic gyroscope, and a fiber length compensator. The fiber length compensator is fixed on a loop pigtail of the fiber-optic gyroscope, and the fiber length compensator includes a peripheral fiber loop and an expansion-and-contraction shaft core capable of realizing deformation of expanding and contracting; and upon detecting that there is a drift in an output of the fiber-optic gyroscope, a length of the peripheral fiber loop of the fiber length compensator is changed by adjusting a coefficient of linear expansion of the expansion-and-contraction shaft core of the fiber length compensator, so that the compensation for the loop pigtail of the fiber-optic gyroscope is realized, and the problem of low accuracy of online adjustment of the pigtail of the fiber-optic gyroscope is solved.

### RELATED APPLICATION

The present disclosure claims priority to Chinese Patent Application No. 202210915632.5, entitle “loop pigtail compensation method for fiber-optic gyroscope, and fiber length compensator”, and filed on Aug. 1, 2022, which is hereby incorporated herein by reference in its entirety.

### TECHNICAL FIELD

The present disclosure relates to the technical field of fiber-optic gyroscopes, and particularly to a loop pigtail compensation method for a fiber-optic gyroscope, and a fiber length compensation.

### BACKGROUND

Compared with the traditional electromechanical gyroscopes, a fiber-optic gyroscope, as an all-solid-state inertial instrument, has no moving parts and wearing parts. In terms of performances, the fiber-optic gyroscope has the advantages of low cost, long service life, light weight, small volume, large dynamic range, wide accuracy application coverage, anti-electromagnetic interference, no drift caused by acceleration, flexible structural design and wide application range.

The fiber-optic gyroscope includes a fiber-optic loop that includes a fiber-optic pigtail. The performance parameters of the fiber-optic pigtail directly influence the final drift performance of the fiber-optic gyroscope. The length of the fiber-optic pigtail is an important parameter thereof, and an equivalent midpoint of the fiber-optic loop of the fiber-optic gyroscope may be changed by adjusting the length of the fiber-optic pigtail. When the equivalent midpoint point of the fiber-optic loop of the fiber-optic gyroscope is located at a center of symmetry of the fiber-optic gyroscope, an equivalent loop of the fiber-optic gyroscope has no Shupe error. However, at present, the length of the pigtail of fiber-optic gyroscope is determined through experimental trimming of the pigtail, which is blind and tentative to some extent, and even if a good result is obtained, it will be time-consuming, inaccurate and difficult to promote the process. Therefore, it is necessary to find a method to compensate the length of the loop pigtail of the fiber-optic gyroscope online.

### SUMMARY

In view of this, the present disclosure provides a loop pigtail compensation method for a fiber-optic gyroscope and a fiber length compensator, which solve the problem of low accuracy of online adjustment of a pigtail of the fiber-optic gyroscope.

In a first aspect, the present disclosure provides a loop pigtail compensation method for a fiber-optic gyroscope, comprising:
fixing a fiber length compensator on a loop pigtail (tail fiber) of a fiber-optic gyroscope, and the fiber length compensator includes a peripheral fiber loop and an expansion-and-contraction shaft core capable of realizing deformation of expanding and contracting; and upon detecting that there is a drift in an output of the fiber-optic gyroscope, adjusting a coefficient of linear expansion of the expansion-and-contraction shaft core of the fiber length compensator to change a length of the peripheral fiber loop of the fiber length compensator, so that a compensation for a length of the loop pigtail of the fiber-optic gyroscope is realized.

In a second aspect, the present disclosure provides a fiber length compensator, including: a peripheral fiber loop and an expansion-and-contraction shaft core, and the expansion-and-contraction shaft core is made of a material capable of realizing deformation of expanding and contracting, so as to compensate a length of the peripheral fiber loop of the fiber length compensator through the deformation of expanding and contracting of the expansion-and-contraction shaft core.

In the technical solutions of the present disclosure, a fiber length compensator is fixed on a loop pigtail of a fiber-optic gyroscope, and the fiber length compensator includes a peripheral fiber loop and an expansion-and-contraction shaft core capable of realizing deformation of expanding and contracting; and upon detecting that there is a drift in an output of the fiber-optic gyroscope, a coefficient of linear expansion of the expansion-and-contraction shaft core of the fiber length compensator is adjusted to change a length of the peripheral fiber loop of the fiber length compensator, so that the compensation for the loop pigtail of the fiber-optic gyroscope is realized, and the problem of low accuracy of online adjustment of the pigtail of the fiber-optic gyroscope is solved.

### BRIEF DESCRIPTION OF THE DRAWINGS

FIGS. 1A and 1B illustrate schematic diagrams of a loop symmetry degree of a fiber-optic gyroscope according to an embodiment of the present disclosure.

FIG. 2 illustrates a flowchart of a loop pigtail compensation method for a fiber-optic gyroscope according to an embodiment of the present disclosure.

FIG. 3 illustrates a structural diagram of an interferometer according to an embodiment of the present disclosure.

FIG. 4 illustrates a structural diagram of a fiber length compensator according to an embodiment of the present disclosure.

FIG. 5 illustrates a diagram of a relationship between a temperature and a coefficient of linear expansion corresponding to a colloidal solution of a fiber length compensator according to an embodiment of the present disclosure.

FIG. 6 illustrates a diagram of a relationship between ultraviolet light power and a coefficient of linear expansion corresponding to a colloidal solution of a fiber length compensator according to an embodiment of the present disclosure.

### DESCRIPTION OF THE EMBODIMENTS

The present disclosure will be described in further detail below with reference to the drawings and embodiments. It is to be understood that the specific embodiments described here are merely illustrative of the present disclosure and are not intended to be limiting. It should also be noted that, for the convenience of description, only parts, rather than all, of structures related to the present disclosure are illustrated in the drawings.

It should also be noted that, for the convenience of description, only parts, rather than all, of the contents related to the present disclosure are illustrated in the drawings. Before the discussion of the exemplary embodiments in more detail, it should be noted that some exemplary embodiments are described as processes or methods depicted as flowcharts. Although a flowchart describes operations (or steps) as a sequential process, many of the operations may be performed in parallel, concurrently, or simultaneously. In addition, the order of the operations may be rearranged. The process may be ended when the operations are completed, but there may be additional steps not included in the drawings. A process may correspond to a method, a function, a procedure, a subroutine, a subprogram, etc.

The performance of the fiber-optic loop of the fiber-optic gyroscope directly influences the accuracy of the fiber-optic gyroscope. When the environmental factors of the environment in which the fiber-optic loop is located change, two beams of optical waves propagating in opposite directions in the fiber-optic loop will produce a nonreciprocal phase difference, and during the demodulation, the nonreciprocal phase shaft is inseparable from a Sagnac phase shift caused by an angular velocity, thus directly influencing the accuracy of the sensitive angular velocity of the fiber-optic loop. The reason for the nonreciprocal phase difference is the asymmetric stress distribution in the fiber-optic loop which causes the change of the phase shift of the fiber-optic loop.

With the continuous maturity of the process of winding the fiber-optic loop of the fiber-optic gyroscope, the symmetry and the uniformity of the internal stress distribution are gradually improved, but the processing of the pigtail of the fiber-optic loop still needs to be guaranteed by a correct and meticulous process, so as to obtain more excellent application performance. However, the pigtail and the waveguide of the fiber-optic gyroscope usually need to be fixed with glue after welding, to meet the requirements of subsequent vibration and temperature change performance. A Shupe error formula shows that the pigtail is located at a tail end of the fiber-optic loop with a largest impact factor, which is very critical to the final drift performance of the fiber-optic gyroscope.

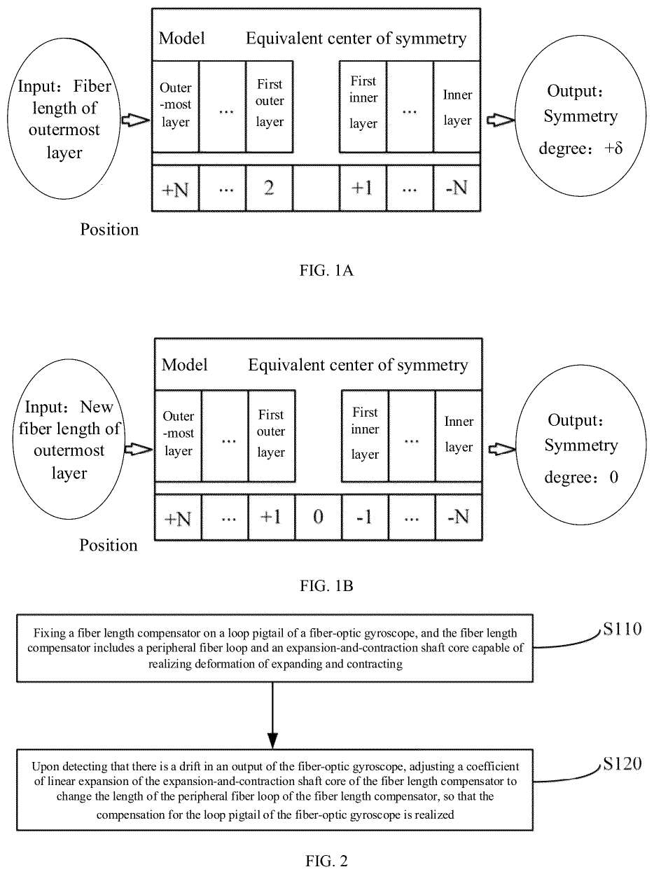

FIGS. 1A and 1B illustrate schematic diagrams of a loop symmetry degree of a fiber-optic gyroscope according to an embodiment of the present disclosure. As illustrated in FIGS. 1A and 1B, the fiber-optic loop is regarded as an equivalent black box model, which includes an input end, an output end and an intermediate model. As illustrated in FIGS. 1A and 1B, the input end is of a fiber length of an outermost layer, the output end is of a fiber length of an innermost layer, and the intermediate model includes the fiber length of each layer. As can be seen from FIGS. 1A and 1B, two beams of light waves propagating in opposite directions in the fiber-optic loop will produce a nonreciprocal phase difference, and during the demodulation, the nonreciprocal phase shaft is inseparable from a Sagnac phase shift caused by an angular velocity, thus directly influencing the accuracy of the sensitive angular velocity of the loop. The fundamental reason for the above nonreciprocal error is the asymmetry of the stress distribution in the fiber-optic sensitive loop, which causes the change of the phase shift of the loop.

With the continuous maturity of the process of winding the loop of the fiber-optic gyroscope, the asymmetry and the uniformity of the stress distribution inside the loop are gradually improved, but the processing of the pigtail of the loop still needs to be guaranteed by a correct and meticulous process, so as to obtain more excellent application performance. However, the pigtail and the waveguide of the fiber-optic gyroscope usually need to be fixed with glue after welding to meet the requirements of subsequent vibration and temperature change performance. A Shupe error formula shows that the pigtail of the loop is located at a tail end of the loop with a largest impact factor, which is very critical to the final drift performance of the gyroscope. The loop may be regarded as an equivalent black box model (see FIGS. 1A and 1B), which includes input, output and intermediate model relationships.

After deeply analyzing a Shupe integral model, the inventor finds that the fiber-optic loop may be divided depending on a position and a weight factor, with a criterion of an equivalent integral sum. If the equivalent integral sum is not zero, the equivalent Shupe error of multipole winding is not zero, as illustrated in FIG. 1A, which means that the equivalent center of symmetry of the fiber-optic loop is not located at the symmetry midpoint, and an output of the fiber-optic gyroscope is +δ. Regardless whether the output of the fiber-optic gyroscope is positive or negative, the equivalent midpoint position can be obtained. As illustrated in FIGS. 1A and 1B, the equivalent integral sum of the outermost layer may be improved by improving the fiber length of the outermost layer and the winding asymmetry of the outermost layer through an artificial control, thus changing the total equivalent integral sum, so that the equivalent midpoint of the final loop can be drifted in position. If a new equivalent midpoint is moved to the symmetrical midpoint (0° position), the final equivalent loop has no Shupe error. The above content is the basic principle of reducing the Shupe error by changing the fiber length distribution to adjust the center of symmetry.

Since the winding of the loop is usually from the inner layer to the outer layer, especially when a gluing process is used, the inner layer is usually coated with glue for curing before the outer layer is wound, the above process makes it complicated or even impossible to adjust the inner layer of the optical fiber. Therefore, it become relatively simple to change the winding of the outer layer of the loop, especially the length of the pigtail of the last layer. If the method of experimental trimming of the pigtail is merely adopted, it is usually blind and tentative to some extent, and even if a good result is obtained, it will be time-consuming, inaccurate and difficult to promote the process. In particular, the high-precision fiber-optic gyroscope usually works at a certain temperature control point. At this time, due to the welding error of the pigtail of the outermost layer or the pigtail of the outermost layer in order to match the winding diameter of the full circle condition during assembly, it is difficult to keep the two pigtails strictly consistent due to the reasons such as the diameter difference between the inner layer and the outer layer during the double-fiber parallel coiling. When the difference between the pigtails at the two ends is not more than 1 to 2 cm, the cutting error of a wire stripper or a cutter is more than 1 cm. Once the welding fails, it is often necessary to cut off the whole circle of the pigtails at the two ends and then fuse them again. The above situation makes the welding assembly process complicated and the waste is serious. It is urgent to find an online accurate pigtail adjustment method.

The pigtail online compensation is the key technology to realize precise winding. The goal of this technology is to calculate an equivalent pigtail length error according to an equivalent drift error model before the curing of the outermost layer of the optical fiber, and then cut or add wind the pigtail according to the length error, and finally complete the curing of the outer layer. This process is similar to a process of solving a set of equations with multivariate parameters. The coefficients of equations are determined through a plurality of groups of input-output relationships, that is, a linear input-output mapping relationship is obtained. The calculation of the equivalent fiber length is actually a reverse process of the above model building, that is, how to determine the new pigtail length after acquiring the mapping relationship between the model parameters, so that the Shupe error meets the predetermined requirements. During the length optimization, it is necessary to set a range of a pigtail cutting length and each cutting step size, and make a traversal calculation, so as to obtain the Shupe calculation error of each step size. If the Shupe error obtained in a certain step meets the index accuracy requirement, the cutting length is output; otherwise, the pigtail cutting length is further increased and the cutting step size is further refined until the index requirements are met. A more concise summarization is to online monitor the Shupe error of the loop of the gyroscope by fine-tuning the length of the pigtail, and if the Shupe error converges within a set satisfactory interval, the fine-tuned length is the required compensation amount of the pigtail.

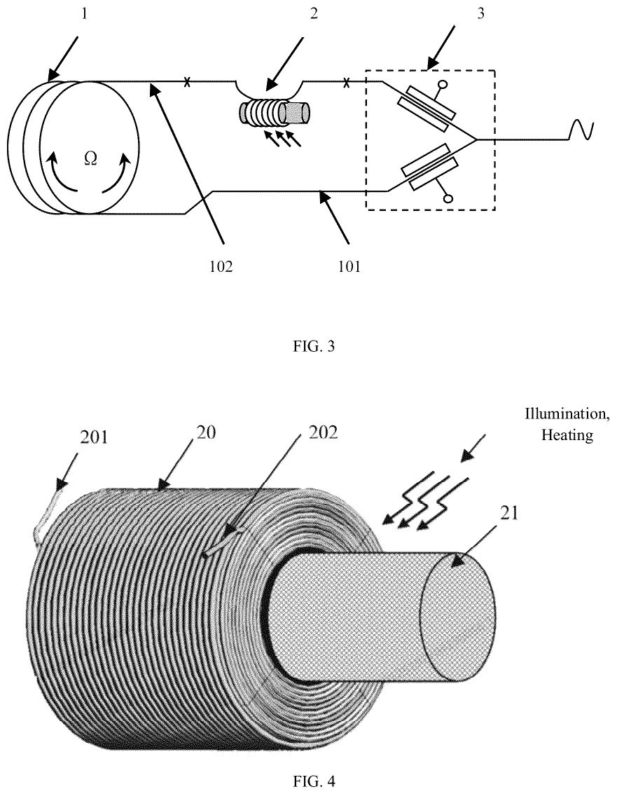

FIG. 2 illustrates a flowchart of a loop pigtail compensation method for a fiber-optic gyroscope according to an embodiment of the present disclosure. In order to solve the above problem, an embodiment of the present disclosure provides a loop pigtail compensation method for a fiber-optic gyroscope. Referring to FIG. 2, the method includes: S110: fixing a fiber length compensator on a loop pigtail of a fiber-optic gyroscope, and the fiber length compensator includes a peripheral fiber loop and an expansion-and-contraction shaft core capable of realizing deformation of expanding and contracting.

S120: upon detecting that there is a drift in an output of the fiber-optic gyroscope, adjusting a coefficient of linear expansion of the expansion-and-contraction shaft core of the fiber length compensator to change the length of the peripheral fiber loop of the fiber length compensator, so that the compensation for the loop pigtail of the fiber-optic gyroscope is realized.

The loop pigtail compensation method for the fiber-optic gyroscope according to the embodiment of the present disclosure abandons the open-loop fiber-optic pigtail cutting method at present and selects an online closed-loop fiber-optic pigtail adjustment method, so that the pigtail length can be accurately and continuously changed, and an interferometer can be kept in a working state during the change, that is, the pigtail can be continuously and accurately adjusted online.

FIG. 3 illustrates a structural diagram of an interferometer according to an embodiment of the present disclosure. As illustrated in FIG. 3, the interferometer includes a fiber-optic gyroscope 1, a fiber length compensator 2 and a phase modulator 3. In the loop of the fiber-optic gyroscope 1, the loop pigtail includes two parts: a reference end pigtail 101 and a compensation end pigtail 102, and a compensation adjuster 2 is added to the compensation end pigtail 102. The basic idea is that the fiber length compensator 2 can dynamically adjust the length of the compensation end pigtail 102, so that the reference end fiber-optic 101 and the compensation end pigtail 102 are symmetrical with respect to a center point of the length of the loop, thus ensuring that the optical paths of the forward and reverse light beams of the interferometer from the loop to the phase modulator 3 are equal, and reducing the Shupe error of the fiber-optic interferometer.

FIG. 4 illustrates a structural diagram of a fiber length compensator according to an embodiment of the present disclosure. The fabrication of the fiber length compensator is illustrated in FIG. 4. The fiber length compensator 2 includes a compensation fiber 20 and an expansion-and-contraction shaft core 21. The compensation fiber 20 includes a left pigtail 201 and a right pigtail 202, and an initial length of the compensation fiber 20 is a difference between the lengths of the reference end pigtail 101 and the compensation end pigtail 102 illustrated in FIG. 3. The compensation fiber 20 is wound around a metal skeleton mandrel with a radius r, and then the wound compensation fiber is coated with glue for curing; after curing, the metal skeleton mandrel is deboned to obtain a compensation fiber loop wound with a hollow core. A colloid expansion-and-contraction shaft core 21 with the same size as the mandrel is made by pouring a colloid solution into the compensation coil and sealing with upper and lower transparent flanges. The colloidal solution is formed into a predetermined shape by photocuring or hot curing (such as illumination or heating in FIG. 4), and then the upper and lower transparent flanges are removed to complete the preparation of the colloidal expansion-and-contraction shaft core 21. Next, the expansion-and-contraction shaft core 21 is inserted into the compensation fiber loop to complete the assembly of the shaft core. In order to reflect the matching effect, interference fit is usually required, and an interference clearance is required to be less than 20 μm.

After the fabrication of the fiber length compensator 2, a Sagnac interferometer is connected to the fiber length compensator 2. Firstly, the fiber length compensator 2 is fixed at an outer edge of the loop of the fiber-optic gyroscope. Next, the left pigtail 201 of the compensation fiber 20 of the fiber length compensator 2 is welded to the reference end pigtail 101 of the loop of the fiber-optic gyroscope 1, the left pigtail 202 of the compensation fiber 20 is welded to the compensation end pigtail 102 of the loop of the fiber-optic gyroscope 1, the pigtails of the compensation fiber except the left pigtail and the right pigtail are coiled around the outermost contour of the loop according to a whole circle, that is, the intermediate pigtails of the fiber length compensator are coiled around the outermost contour of the loop of the fiber-optic gyroscope. Of course, it is necessary to complete the welding between the reference end pigtail 101 and the compensation end pigtail 102 of the loop of the fiber-optic gyroscope 1, so as to ensure that the entire reference end pigtail 101 is coiled around the outer contour of the optical fiber according to a whole circle. So far, the whole assembly of the interferometer is completed.

Next, the fiber-optic gyroscope is assembled and tested, and the specific content is relatively routine, which will not be repeated here. The main purpose of this step is to collect zero bias of fiber-optic gyroscope. The fiber-optic gyroscope is heated to a constant temperature control point, the zero bias of the fiber-optic gyroscope is recorded, and a difference between the zero bias at the temperature control point and the normal temperature point is calculated. The difference is a zero bias difference to be compensated and is related to the length of the compensation fiber.

Finally, the pigtails of the fiber length compensator 2 are fixed and the fiber length is adjusted.

The calculation method of the equivalent fiber length is a differential equation Δl=l₀Δ(α₂t), where Δ is a differential operator for variation calculation, l is a length of the peripheral fiber loop after adjustment by the fiber length compensator, l₀ is an initial length of the peripheral fiber loop before the adjustment of the fiber length compensator, t is a Celsius temperature at which the colloidal solution is adjusted, and αₜ is a coefficient of linear expansion corresponding to the colloidal solution at t degrees Celsius.

FIG. 5 illustrates a diagram of a relationship between a temperature and a coefficient of linear expansion corresponding to a colloidal solution of a fiber length compensator and temperatures according to an embodiment of the present disclosure. The coefficient of linear expansion corresponding to the colloidal solution is measured in advance by a Dynamic Mechanical Analyzer (DMA), as illustrated in FIG. 5, and the abscissa represents a Celsius temperature t when the colloidal solution is adjusted, and the ordinate represents the coefficient of linear expansion of the colloidal solution.

The change rate of the corresponding coefficient of linear expansion is obtained from the derivation of the above curve, and then substituted into a relational expression to obtain the change of the fiber length. At first, the initial length lo of the peripheral fiber loop before the adjustment of the fiber length compensator is kept equal to that of a reference end pigtail 101 of the fiber-optic gyroscope. Due to the change of the external temperature and other conditions, when the equivalent optical paths of the two ends of the loop are not equal with respect to a center point, there is a drift in the output of the gyroscope, and the magnitude of the drift is related to a length difference of the pigtails of the outermost layer. By changing a curing temperature of a curing glue of the mandrel, the coefficient of linear expansion of the glue can be adjusted very sensitively, so as to adjust the overall fiber length change of the fiber length compensator. The fiber length change is calculated in the above formula, and a temperature rise leads to an expansion and a temperature drop leads to a contraction. The above change may be adjusted by a closed-loop negative feedback of the fiber-optic gyroscope, that is, by continuously adjusting the curve of the coefficient of linear expansion until the zero-bias error of the fiber-optic gyroscope disappears.

Generally, in order to improve the overall amplification ratio, l₀=100 m is required. In an example where the colloidal solution is resin, the compensation range of the length of the peripheral fiber loop of the fiber length compensator is ±2.5 cm. For a 0.0001°/h high-precision fiber-optic gyroscope with a fiber length of 5000 m, an adjustment range of a drift of the zero bias is about −0.0005°/h to 0.0005°/h, and a subdivision accuracy is 0.000025°/h. It is clear that the above adjustment is accurate enough. Moreover, after the error is compensated, the temperature of the colloid is kept at a calculated temperature point to carry out continuous curing at a constant temperature, thereby ensuring that the curing is sufficient and no reversible reaction occurs, and then the whole adjustment is completed.

In addition, when the temperature-variable linear expansion method is adopted, the Shupe compensation effect is easily reduced due to the uneven heating of a temperature box. A better way is to adopt a photocuring method, such as ultraviolet light curing, which can better inhibit the cross-influence caused by a thermal stress.

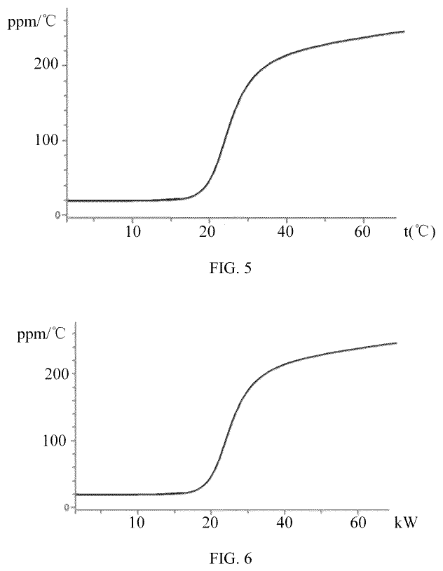

FIG. 6 illustrates a diagram of a relationship between ultraviolet power and a coefficient of linear expansion corresponding to a colloidal solution of a fiber length compensator and ultraviolet light powers according to an embodiment of the present disclosure.

When the colloid solution is an ultraviolet light curing resin, the shaft core is irradiated with for example ultraviolet light evenly distributed in a circumferential direction, the coefficient of linear expansion of the mandrel can be sensitively changed by adjusting the power of an ultraviolet lamp and an irradiation time, and the relationship between the coefficient of linear expansion of the colloidal solution and ultraviolet light powers is illustrated in FIG. 6. It should be noted that the influence of the temperature change on the coefficient of linear expansion during curing is negligible. Another advantage of the method is that irradiation moulding of the phase compensator can be done individually using a hand-held ultraviolet lamp.

To be noted, those described above are only exemplary embodiments of the present disclosure and the applied technical principles. Persons skilled in the art will understand that the present disclosure is not limited to the specific embodiments here, and various obvious changes, readjustments and substitutions can be made by those skilled in the art without departing from the protection scope of the present disclosure. Therefore, although the present disclosure has been described in detail through the above embodiments, the present disclosure is not limited thereto, and more other equivalent embodiments may be included without departing from the concept of the present disclosure. The scope of the present disclosure is determined by the scope of the appended claims.

1. A loop pigtail length compensation method for a fiber-optic gyroscope, comprising:
fixing a fiber length compensator on a loop pigtail of a fiber-optic gyroscope, wherein the fiber length compensator comprises a peripheral fiber loop and an expansion-and-contraction shaft core capable of realizing deformation of expanding and contracting; and upon detecting that there is a drift in an output of the fiber-optic gyroscope,
adjusting a coefficient of linear expansion of the expansion-and-contraction shaft core of the fiber length compensator to change a length of the peripheral fiber loop of the fiber length compensator, so that a compensation for a length of the loop pigtail of the fiber-optic gyroscope is realized.

2. The method according to claim 1, wherein the expansion-and-contraction shaft core is made of high-elastic colloid; the adjusting the coefficient of linear expansion of the expansion-and-contraction shaft core of the fiber length compensator to change the length of the peripheral fiber loop of the fiber length compensator comprises:
adjusting a curing temperature of the expansion-and-contraction shaft core through a temperature-variable linear expansion method;
when the curing temperature rises, the length of the peripheral fiber loop of the fiber length compensator increases as the coefficient of linear expansion of the high-elastic colloid increases; and
when the curing temperature drops, the length of the peripheral fiber loop of the fiber length compensator decreases as the coefficient of linear expansion of the high-PATENT elastic colloid decreases.

3. The method according to claim 1, wherein the expansion-and-contraction shaft core is made of ultraviolet light curing resin; the adjusting the coefficient of linear expansion of the expansion-and-contraction shaft core of the fiber length compensator to change the length of the peripheral fiber loop of the fiber length compensator comprises:
adjusting the coefficient of linear expansion of the ultraviolet light curing resin by a photocuring method so as to change the length of the peripheral fiber loop of the fiber length compensator.

4. The method according to claim 3, wherein the adjusting the coefficient of linear expansion of the ultraviolet light curing resin by the photocuring method so as to change the length of the peripheral fiber loop of the fiber length compensator comprises:
irradiating the ultraviolet light curing resin with ultraviolet light evenly distributed in a circumferential direction; and adjusting power of the ultraviolet light and/or irradiation time of the ultraviolet light to change the coefficient of linear expansion of the ultraviolet light curing resin, so as to change the length of the peripheral fiber loop of the fiber length compensator.

5. The method according to claim 1, wherein a relationship between the coefficient of linear expansion of the expansion-and-contraction shaft core and the length of the peripheral fiber loop of the fiber length compensator is Δl=l₀Δ(αₜt), where Δ is a differential operator for variation calculation, l is a length of the peripheral fiber loop after adjustment by the fiber length compensator, l₀ is an initial length of the peripheral fiber loop before the adjustment by the fiber length compensator, t is a Celsius temperature at which the expansion-and-contraction shaft core is adjusted, and αₜ, is a coefficient of linear expansion corresponding to the expansion-and-contraction shaft core at t degrees Celsius.

6. The method according to claim 5, wherein l₀=100 m, a compensation range of the length of the peripheral fiber loop of the fiber length compensator is ±2.5 cm, and a subdivision accuracy of the fiber length compensator is 0.000025°/h.

7. The method according to claim 5, wherein the loop pigtail of the fiber-optic gyroscope comprises a reference end pigtail and a compensation end pigtail, and the fiber length compensator is fixed at an outer edge of the compensation end pigtail; the initial length of the peripheral fiber loop is equal to a difference between the length of the reference end pigtail and the length of the compensation end pigtail.

8. The method according to claim 1, wherein before fixing the fiber length compensator on the loop pigtail of a fiber-optic gyroscope, the method further comprises: winding a compensation fiber around a metal skeleton mandrel with a radius r, and then the wound compensation fiber is coated with glue for curing, wherein the compensation fiber comprises a left pigtail, a right pigtail and an intermediate pigtail;
debonding the metal skeleton mandrel to obtain a compensation fiber loop wound with a hollow core; pouring a high-elastic colloid solution into the compensation fiber loop for photocuring or hot curing, so that the high-elastic colloid solution is shaped to obtain the expansion-and-contraction shaft core, and the assembly of the compensation fiber loop and the expansion-and-contraction shaft core is completed to obtain the fiber compensator, wherein the expansion-and-contraction shaft core and the compensation fiber loop are in interference fit, and an interference clearance is less than or equal to 20 μm.

9. The method according to claim 8, wherein the step of fixing the fiber length compensator on the loop pigtail of a fiber-optic gyroscope comprises: fixing the fiber length compensator at an outer edge of the loop pigtail of the fiber-optic gyroscope; welding the left pigtail to a reference end pigtail of the fiber-optic gyroscope and welding a right pigtail to the compensation end pigtail of the fiber-optic gyroscope; coiling the intermediate pigtail of the fiber length compensator around an outermost contour of the loop of the fiber-optic gyroscope; and welding the reference end pigtail of the fiber-optic gyroscope and the compensation end pigtail of the fiber-optic gyroscope.

10. A fiber length compensator, comprising: a peripheral fiber loop and an expansion-and-contraction shaft core, wherein the expansion-and-contraction shaft core is made of a material capable of realizing deformation of expanding and contracting, so as to compensate a length of the peripheral fiber loop of the fiber length compensator through the deformation of expanding and contracting of the expansion-and-contraction shaft core.

11. The method according to claim 6, wherein the loop pigtail of the fiber-optic gyroscope comprises a reference end pigtail and a compensation end pigtail, and the fiber length compensator is fixed at an outer edge of the compensation end pigtail; the initial length of the peripheral fiber loop is equal to a difference between the length of the reference end pigtail and the length of the compensation end pigtail.
